(19) United States
(12) Patent Application Publication
(10) Pub. No.: US 2012/0055129 A1
(43) Pub. Date: Mar. 8, 2012

(54) ROTARY MOWER FOR APPLYING CHEMICALS TO VEGETATION

(75) Inventor: Montgomerie Summach, St. Brieux (CA)

(73) Assignee: HIGHLINE MANUFACTURING LTD., Vonda (CA)

(21) Appl. No.: 13/206,678

(22) Filed: Aug. 10, 2011

(30) Foreign Application Priority Data
Sep. 2, 2010 (CA) 2714369

(51) Int. Cl. A01D 19/00

(52) U.S. Cl. 56/16.8

(57) ABSTRACT

A chemical applying apparatus for use on a rotary mower that includes a mower deck, a blade pan under the mower deck mounted to a driven shaft, and a plurality of blades attached to the blade pan. A slinger ring is attached to a top surface of the blade pan such that a center of the slinger ring substantially coincides with a rotational axis of the driven shaft, and a bottom edge of the slinger ring is sealed to the blade pan. The slinger ring slopes upward and inward from the bottom edge thereof to the top edge thereof. Discharge ports extend through the blade pan adjacent to and inside the slinger ring. A conduit is fixed to the mower deck and oriented to direct chemical onto the top surface of the blade pan inside the slinger ring, and a chemical source delivers chemical through the conduit.

This invention is in the field of rotary mowers and in particular a rotary mower for applying chemicals such as herbicides, to vegetation as same is being mowed.

### BACKGROUND

In some situations it is desired to apply chemicals such as growth regulators, herbicides, pesticides, fungicides, or the like to vegetation as it is being cut with a rotary mower. In addition to conveniently combining two operations in one implement pass, applying many chemicals to freshly cut ends of the growing plants greatly increases efficacy of the chemicals, and allows the application rate to be substantially reduced compared to when applying to uncut growing plants.

U.S. Pat. Nos. 6,125,621 and 6,374,586 to Burch and U.S. Pat. No. 4,926,622 to McKee describe rotary mower apparatuses for such an operation. The disclosed apparatuses includes a tank and pump mounted on the mower, and a conduit network through or around the rotating drive shaft and then along the arms of the blades. The conduit network is relatively complex requiring considerable machining and fitting, and also requiring seals to connect the pressurized liquid chemical from the pump to the rotating shaft. Thus the disclosed apparatus is costly to manufacture, and requires significant maintenance to avoid failure of the various components such as seals.

U.S. Pat. No. 5,329,752 to Milbourn discloses a brush cutter that includes a spray nozzle. In operation the rotating blades of the brush cutter are stopped when vegetation has been cut and then the cut area is sprayed from the nozzle.

U.S. Pat. No. 3,332,221 to McCain discloses a push type lawn mower with a chemical application apparatus. The apparatus comprises a doughnut shaped distributor that attaches to the motor shaft above the blade and under the housing of the mower, with the shaft passing through the hole of the doughnut. The outer wall of the circular doughnut slopes down and out from a top plate, forming the top of the doughnut, to a bottom plate that forms the bottom of the doughnut, and an upright inner wall forms the hole. A slot is cut in the top plate such that a spout that passes through the housing and is fixed to the housing can project into the slot while the blade and doughnut rotate with the shaft. A plurality of ports pass through the bottom plate near the outer wall. Chemical is directed through the spout into the inside of the doughnut and centrifugal force causes the chemical to move toward the outer wall where same passes out of the doughnut through the ports and onto the cut vegetation.

### SUMMARY OF THE INVENTION

It is an object of the present invention to provide a rotary mower with a chemical application apparatus that overcomes problems in the prior art.

In a first embodiment the present invention provides a chemical applying apparatus for use on a rotary mower that includes a mower deck adapted for movement along the ground, a blade pan under the mower deck mounted to a driven shaft extending down through the mower deck, and a plurality of blades attached to the blade pan. The chemical applying apparatus comprises a slinger ring attached to a top surface of the blade pan such that a center of the slinger ring substantially coincides with a rotational axis of the driven shaft, and such that a bottom edge of the slinger ring is substantially sealed to the top surface of the blade pan. The slinger ring slopes upward and inward toward the center thereof from the bottom edge thereof to the top edge thereof. A plurality of discharge ports extend through the blade pan at spaced apart locations adjacent to and inside the slinger ring. A conduit is fixed to the mower deck and oriented to direct chemical onto the top surface of the blade pan inside the slinger ring, and a chemical source is operative to deliver chemical through the conduit.

In a second embodiment the present invention provides a method of applying a chemical with a rotary mower that includes a mower deck adapted for movement along the ground, a blade pan under the mower deck mounted to a driven shaft extending down through the mower deck, and a plurality of blades attached to the blade pan. The method comprises attaching a slinger ring to a top surface of the blade pan such that a center of the slinger ring substantially coincides with a rotational axis of the driven shaft, and such that a bottom edge of the slinger ring is substantially sealed to the top surface of the blade pan; wherein the slinger ring slopes upward and inward toward the center thereof from the bottom edge thereof to the top edge thereof; providing a plurality of discharge ports extending through the blade pan at spaced apart locations adjacent to and inside the slinger ring; fixing a conduit to the mower deck and orienting the conduit to direct chemical onto the top surface of the blade pan inside the slinger ring; and rotating the driven shaft and blade pan and delivering chemical through the conduit onto the top surface of the blade pan inside the slinger ring such that centrifugal force moves the chemical along the top surface of the blade pan to the slinger ring and then out through the discharge ports.

Compared to the prior art systems for applying chemicals with a rotary mower, the present invention provides a simple, and economical chemical applicator for large rotary mowers with single or multiple mower decks that requires little maintenance. A polygonal slinger ring also has added benefits compared to a circular slinger ring. In a polygonal slinger ring, for example one that is square in shape, with discharge ports at the corners thereof, the chemical is thrown by centrifugal force along each straight wall of the square to the corner, which is the farthest point from the center, where same flows out the discharge port. In contrast in a circular slinger ring, centrifugal force throws the chemical against the inside of the whole ring more or less equally, and then must find its way by gravity along the ring to a discharge port before flowing out on to the plants.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective exploded view of a rotary mower such as is known in the prior art with an embodiment of a chemical applying apparatus of the present invention installed thereon;

FIG. 2 is a top perspective view of the blade pan of the embodiment of FIG. 1 showing the slinger ring and discharge ports;

FIG. 3 is a schematic side view of the embodiment of FIG. 1;

FIG. 4 is a schematic top view of an apparatus of the invention installed on a rotary mower with three sections, such as is known in the prior art;

FIG. 5 is a schematic side view showing a detail sectional side view of the slinger ring and its mounting to the blade pan, and the discharge ports;

FIG. 6 is a top perspective view of the blade pan of an alternate embodiment of a chemical applying apparatus of the present invention installed thereon where the slinger ring is square and discharge ports are located at the corners of the slinger ringer;

FIG. 7 is a schematic top view of the slinger ring of FIG. 6 showing the forces exerted on the chemical;

FIG. 8 is a schematic top view of an alternate embodiment of a chemical applying apparatus of the present invention where the slinger ring is hexagonal and discharge ports are located at the corners of the slinger ring.

### DETAILED DESCRIPTION OF THE ILLUSTRATED EMBODIMENTS

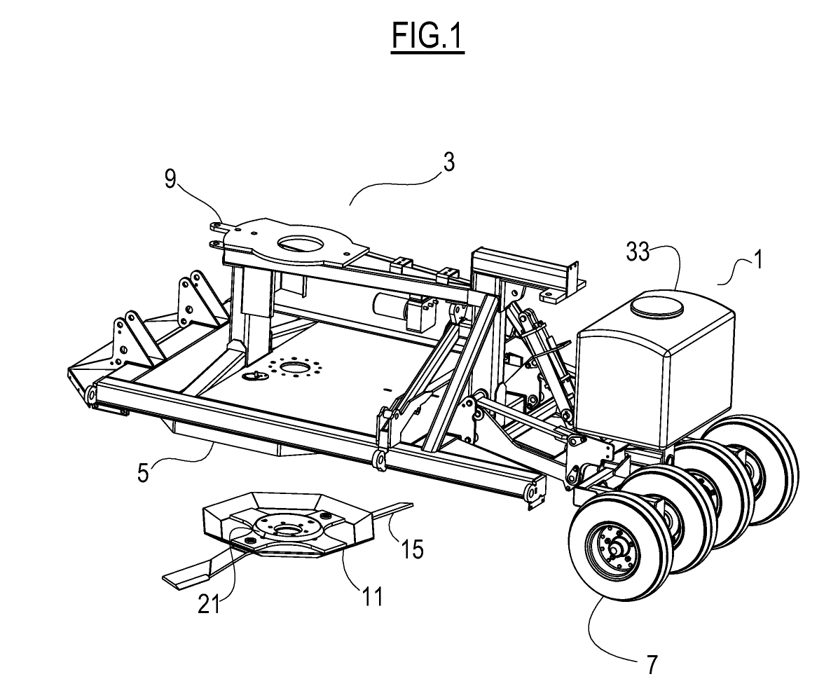

FIG. 1 illustrates a perspective exploded view of a rotary mower 3 such as is known in the prior art with an chemical applying apparatus 1 of the present invention installed thereon. The rotary mower 3 includes a mower deck 5 adapted for movement along the ground. The illustrated mower deck 5 is supported on wheels 7 at the rear of the deck 5, and a hitch 9 at the front of the deck that is attached to a tractor. The rotary mower 3 has a blade pan 11 under the mower deck 5 that is mounted to a driven shaft 13, as seen in FIG. 3, extending down through the mower deck 5. A plurality of blades 15 are attached to the bottom of the blade pan 11.

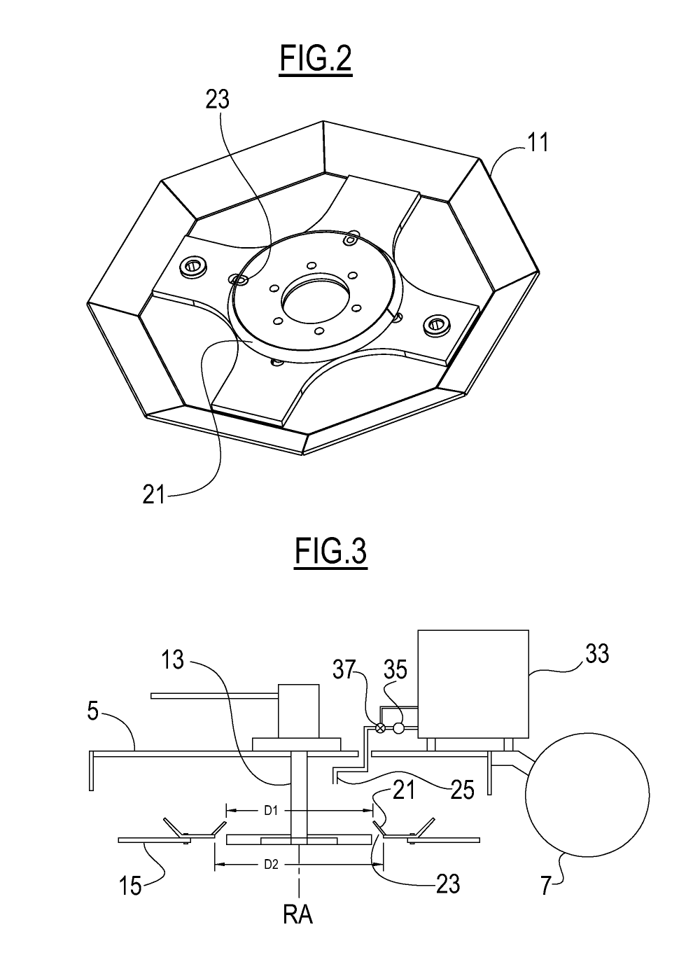

FIG. 3 schematically illustrates an embodiment of a chemical applying apparatus 1 of the present invention for use on a rotary mower 3 such as is illustrated in FIG. 1. The chemical applying apparatus 1 comprises a slinger ring 21 attached to a top surface of the blade pan 11 such that a center of the slinger ring substantially coincides with a rotational axis of the driven shaft 13, and such that a bottom edge of the slinger ring 21 is substantially sealed to the top surface of the blade pan 11. A typical blade pan 11 with a substantially circular shaped slinger ring 21 installed therein is shown in FIG. 2. While the circular slinger ring 21 has sufficient utility for the purpose of the invention, a square shaped slinger ring has certain benefits over the circular slinger ring, as described below.

The diameter D1 of the top edge of the slinger ring 21 is less than the diameter D2 of the bottom edge of the slinger ring, such that the slinger ring 21 slopes upward and inward from the bottom edge thereof to the top edge thereof.

A plurality of discharge ports 23 extend through the blade pan 11 at spaced apart locations adjacent to and inside the slinger ring 21. When installing the apparatus 1 in a prior art rotary mower, these ports can be cut or drilled through the blade pan 11.

A conduit 25 is fixed to the mower deck 5 and is oriented to direct chemical onto the top surface of the blade pan 11 inside the slinger ring 21, and a chemical source is operative to deliver chemical through the conduit 25. Commonly the mower deck 5 will already define a hole therethrough of some kind, such as for providing access to blade bolts, or like purposes. Conveniently the conduit 25 can extend through the hole from a top of the mower deck 5 to a bottom side of the mower deck above the blade pan 11, and then be secured to the mower deck so that chemical coming out of the conduit will land on the top surface of the blade pan 11 inside the slinger ring 21. If no such hole exists a hole can be bored through the deck 5 at a suitable location. The conduit 25 can be extend under the deck 5 to a suitable location, as schematically illustrated in FIG. 3.

A chemical source is operative to deliver chemical through the conduit 25. In the illustrated apparatus 1, the chemical source is provided by a tank 33 mounted on a rear portion of the mower deck 5 where same is supported by the wheels 7. A pump 35 and suitable valves 37 control the flow of chemical through the conduit 25.

Rotating the driven shaft 13 and blade pan 11 at high speed, as when using the mower to cut vegetation, while delivering chemical through the conduit 25 onto the top surface of the blade pan 11 inside the slinger ring 21 results in the chemical moving along the top surface of the blade pan 11 to the slinger ring 21, where same is blocked from moving further along the blade pan 11, and so moves out through the discharge ports 23 in response to the centrifugal force of the high speed rotation. As schematically illustrated in FIG. 5, the high speed rotation of the blade pan 11 causes the chemical 29 to exit through the ports 23 in a spray. The ports 23 can be oriented at an outward angle as illustrated in FIG. 5, to direct the chemical 29 outward to provide improved chemical coverage of the entire width of cut of the rotary mower 3. A spout 31 could be added to further direct chemical outward.

The inward slope of the slinger ring 21 also keeps the chemical 29 contained so same passes out through the ports rather than over the top of the slinger ring. The present inventor has found that sloping the ring is sufficient to keep the chemical contained as the blade pan tilts up and down following uneven terrain, and so it is not necessary to fully enclose the chemical as was done in the prior art. The resulting apparatus thus is very simple and convenient to install on existing rotary mowers at an economical cost.

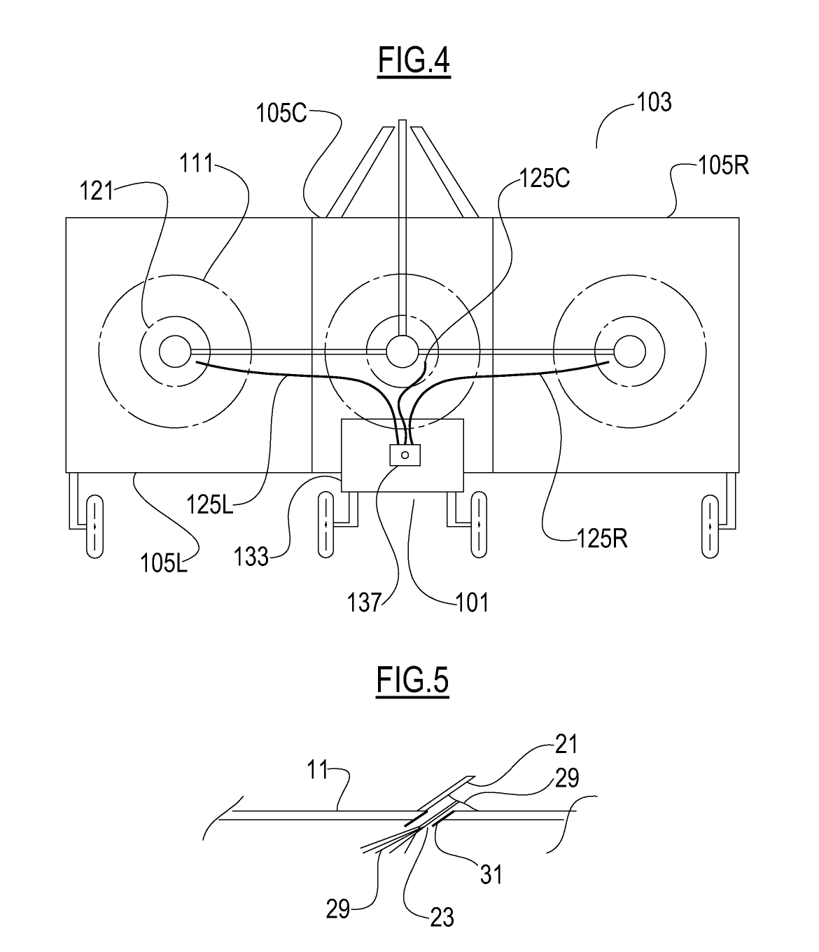

FIG. 4 schematically illustrates a typical three section rotary mower 103 such as is known in the prior art with a chemical applying apparatus 101 of the present invention installed thereon. Blade pans 111 and slinger rings 121 as described above are mounted under the center, right, and left mower decks 105C, 105R, 105L, and center, right, and left conduits 125C, 125R, 125L, extend through holes in the corresponding mower decks and are oriented to direct chemical onto top surfaces of the corresponding blade pans 111 inside the corresponding slinger rings 121 also as described above.

A control 137 is operative to selectively direct chemical to the center, right, and left conduits 125C, 125R, 125L, so that the operator can apply chemical to each conduit and mower deck individually. The chemical source includes a tank 133 mounted on a rear portion of the center mower deck 105C and a pump and hardware as required.

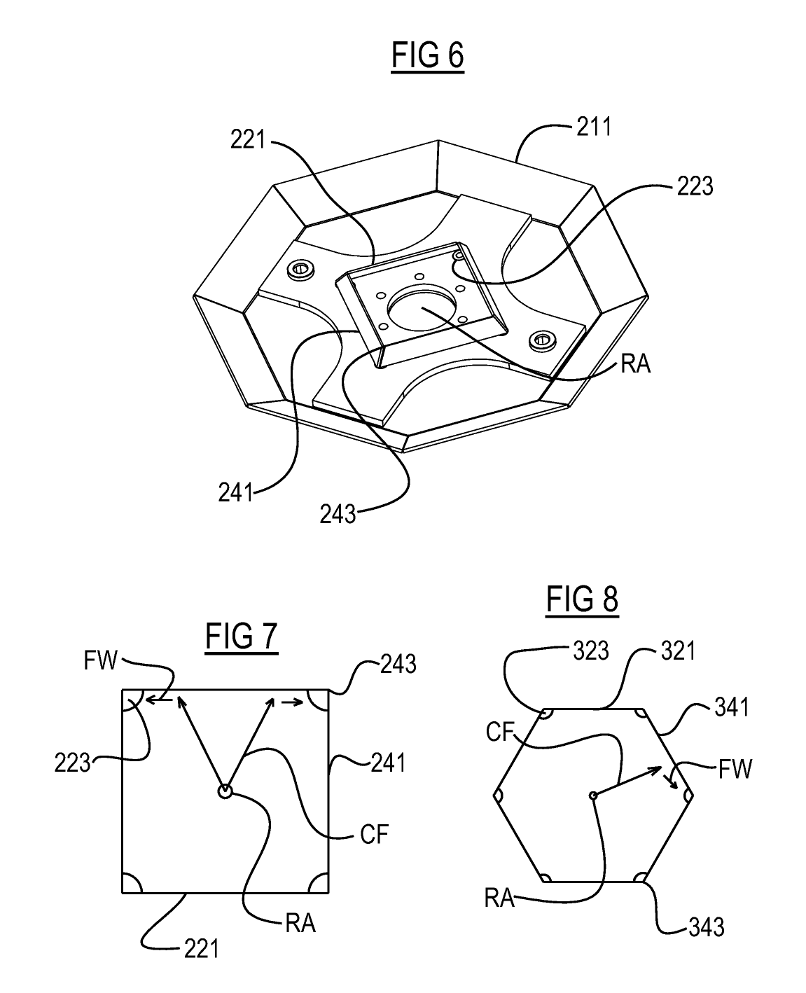

FIGS. 6 and 7 illustrate a square shaped slinger ring 221 with straight ring wall segments 241 that meet at corners 243. A discharge port 223 extends through the blade pan 211 inside the slinger ring 221 adjacent to each corner 243. As schematically illustrated in FIG. 7 centrifugal forces CF are exerted radially from the rotational axis RA on chemical deposited inside the slinger ring 221. Thus when the chemical is thrown out into contact with the straight ring wall segments 241, at all points on the ring wall segments 241, except the point directly at right angles with the radius, there is a force component FW along the wall segments 241 such that the chemical is thrown along the wall toward the corners 243 and out through the discharge ports 223 at each corner 243.

In contrast with the circular slinger ring 21 described above, once the chemical is thrown out into contact with the circular ring 21, there is no additional force component towards the discharge ports 23, and the chemical moves to the ports only by gravity as the blade pan tilts in undulating or sloped terrain, or as the chemical builds up and flows down into the discharge ports.

FIG. 8 schematically illustrates a hexagonal slinger ring 321 with straight ring wall segments 341 that meet at corners 343. A discharge port 323 extends through the blade pan inside the slinger ring 321 adjacent to each corner 343. As schematically illustrated in FIG. 8 centrifugal forces CF are again exerted radially from the rotational axis RA on chemical deposited inside the slinger ring 321. Again then when the chemical is thrown out into contact with the straight ring wall segments 341, at all points on the ring wall segments 341, again except the point directly at right angles with the radius, there is a force component FW along the wall segments 341 such that the chemical is thrown along the wall toward the corners 343 and out through the discharge ports 323 at each corner 343.

It is contemplated that other polygonal shapes with straight ring wall segments would work the same way. It is also contemplated that where the ring wall segments are substantially equal in length the distribution of chemical through the ports would be more balanced and even.

Compared to the prior art large rotary mowers requiring a conduit network through the rotating drive shaft and then along the arms of the blades, requiring considerable machining and fitting, and also requiring high maintenance seals, the present invention provides a simple, and economical chemical applicator for large rotary mowers with one, three, or any number of mower decks that requires little maintenance.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A chemical applying apparatus for use on a rotary mower that includes a mower deck adapted for movement along the ground, a blade pan under the mower deck mounted to a driven shaft extending down through the mower deck, and a plurality of blades attached to the blade pan, the chemical applying apparatus comprising:
a slinger ring attached to a top surface of the blade pan such that a center of the slinger ring substantially coincides with a rotational axis of the driven shaft, and such that a bottom edge of the slinger ring is substantially sealed to the top surface of the blade pan;
wherein the slinger ring slopes upward and inward toward the center thereof from the bottom edge thereof to the top edge thereof;
a plurality of discharge ports extending through the blade pan at spaced apart locations adjacent to and inside the slinger ring;
a conduit fixed to the mower deck and oriented to direct chemical onto the top surface of the blade pan inside the slinger ring; and
a chemical source operative to deliver chemical through the conduit.

2. The apparatus of claim 1 wherein the mower deck defines a hole therethrough, and wherein the conduit extends through the hole from a top of the mower deck to a bottom side of the mower deck above the blade pan.

3. The apparatus of claim 1 wherein the mower deck is mounted on wheels located at a rear of the mower deck, and wherein the chemical source includes a tank mounted on a rear portion of the mower deck.

4. The apparatus of claim 1 wherein the rotary mower includes center, right, and left mower decks, and wherein corresponding center, right, and left slinger rings are attached to top surfaces of center, right, and left blade pans under the corresponding center, right, and left mower decks, and wherein center, right, and left conduits extend through holes in the corresponding mower decks and are oriented to direct chemical onto top surfaces of the corresponding blade pans inside the corresponding slinger rings.

5. The apparatus of claim 4 comprising a control operative to selectively direct chemical to the center, right, and left conduits.

6. The apparatus of claim 4 wherein the center mower deck is mounted on wheels located at a rear of the center mower deck, and wherein the chemical source includes a tank mounted on a rear portion of the center mower deck.

7. The apparatus of claim 1 wherein the discharge ports are angled outward to direct the chemical outward.

8. The apparatus of claim 1 wherein the slinger ring is substantially circular.

9. The apparatus of claim 1 wherein the slinger ring is polygonal and comprises a plurality of substantially straight ring wall segments that meet at corners, and wherein a discharge port extends through the blade pan inside the slinger ring adjacent to each corner.

10. The apparatus of claim 9 wherein the ring wall segments are substantially equal in length.

11. The apparatus of claim 10 wherein the slinger ring is substantially square.

12. A method of applying a chemical with a rotary mower that includes a mower deck adapted for movement along the ground, a blade pan under the mower deck mounted to a driven shaft extending down through the mower deck, and a plurality of blades attached to the blade pan, the method comprising:
attaching a slinger ring to a top surface of the blade pan such that a center of the slinger ring substantially coincides with a rotational axis of the driven shaft, and such that a bottom edge of the slinger ring is substantially sealed to the top surface of the blade pan;
wherein the slinger ring slopes upward and inward toward the center thereof from the bottom edge thereof to the top edge thereof;
providing a plurality of discharge ports extending through the blade pan at spaced apart locations adjacent to and inside the slinger ring;
fixing a conduit to the mower deck and orienting the conduit to direct chemical onto the top surface of the blade pan inside the slinger ring; and
rotating the driven shaft and blade pan and delivering chemical through the conduit onto the top surface of the blade pan inside the slinger ring such that centrifugal force moves the chemical along the top surface of the blade pan to the slinger ring and then out through the discharge ports.

13. The method of claim 12 wherein the mower deck defines a hole therethrough, and wherein the conduit extends through the hole from a top of the mower deck to a bottom side of the mower deck above the blade pan.

14. The method of claim 12 wherein the mower deck is mounted on wheels located at a rear of the mower deck, and comprising mounting a tank on a rear portion of the mower deck and delivering chemical by pumping chemical from the tank through the conduit.

15. The method of claim 12 wherein the rotary mower includes center, right, and left mower decks, and wherein corresponding center, right, and left slinger rings are attached to top surfaces of center, right, and left blade pans under the corresponding center, right, and left mower decks, and comprising fixing center, right, and left conduits to the corresponding mower decks and orienting the center, right, and left conduits to direct chemical onto top surfaces of the corresponding blade pans inside the corresponding slinger rings.

16. The method of claim 15 comprising operating a control to selectively direct chemical to the center, right, and left conduits.

17. The method of claim 15 wherein the center mower deck is mounted on wheels located at a rear of the center mower deck, and comprising mounting a tank on a rear portion of the center mower deck and delivering chemical by pumping chemical from the tank through the center, right, and left conduits.

18. The method of claim 12 wherein the discharge ports are angled outward to direct the chemical outward.

19. The method of claim 12 wherein the slinger ring is substantially circular.

20. The method of claim 12 wherein the slinger ring is polygonal and comprises a plurality of substantially straight ring wall segments that meet at corners, and wherein a discharge port extends through the blade pan inside the slinger ring adjacent to each corner.

21. The method of claim 20 wherein the ring wall segments are substantially equal in length.

22. The method of claim 21 wherein the slinger ring is substantially square.
